(19) United States
(12) Patent Application Publication
(10) Pub. No.: US 2009/0196410 A1
(43) Pub. Date: Aug. 6, 2009

(54) METHOD AND SYSTEM OF CALL TREATMENT BASED ON A CALLED PARTY CALENDAR

(76) Inventor: Babu Mani, Murphy, TX (US)

Correspondence Address: ERICSSON INC., 6300 LEGACY DRIVE, M/S EVR 1-C-11, PLANO, TX, 75024, US

(21) Appl. No.: 12/025,172

(22) Filed: Feb. 4, 2008

(51) Int. Cl. H04M 3/42

(52) U.S. Cl. 379/207.03

(57) ABSTRACT

A method and system for coupling, e.g., via the Internet or via other data channel, calendar and scheduling information or data from a calendar and scheduling software application to a functional node of a telecommunications system such as a service platform, an application server or service control point. Alternatively, the present invention is a node coupled to a telecommunication system, the node adapted to accept calendaring and scheduling information or data from a calendar and scheduling software application, and, based on such data, control the treatment of calls made to a subscriber. In this manner, the subscriber can specify the treatment of calls placed to the subscriber based on the subscriber's calendar or scheduling software application.

### BACKGROUND

The present invention relates to telecommunication systems. More particularly, and not by way of limitation, the present invention is directed to a method and system for a called party to control the disposition of calls that are made to the subscriber's terminal. As used herein, the following abbreviations shall have the following meanings:

AT—Answer Tones

CAMEL—Customized Applications for Mobile Network Enhanced Logic

CPC—Calling Party's Category

CRBT—Color Ringback Tone

GMSC—Gateway MSC

HLR—Home Location Register

HSS—Home Subscriber Server

ISUP—ISDN User Part

LIDB—Line Information Database

MSC—Mobile Switching Center

RBT—Ringback Tone

SCP—Service Control Point

SIP—Session Initiation Protocol

In a call made over a telecommunications system using a wireless infrastructure, wireline infrastructure or both, a calling party uses the telecommunication infastructure to signal a called party. The party that initiates the call is referred to as the caller or calling party, and the party receiving the call is referred to as the called party, terminating party or subscriber. As used herein, it is assumed that the subscriber and the called party are the same person.

RBT is a service provided to the subscribers of telecommunication service providers that enables the subscribers to substitute the regular audible ringing provided to a calling party with a tone or audio clip selected by the called party during the process of connecting a call. This service is also known as Color Ringback Tones (CRBT) and Answer Tones (AT). It is also possible to substitute the tone or the audio clip with other media content. Thus the RBT content presented to callers can be video, text, graphics, photos, etc., only limited by the capabilities of the caller's handset and the transmission capabilities of the telecommunications network. RBT is a terminating service. In other words, the terminating user is the called party who subscribes to the RBT service and callers listen to RBT content as specified by the subscriber who is the called party.

Calendaring and scheduling software applications are well known in the art. The use of calendaring and scheduling has grown considerably in the last twenty years. Individuals, enterprise and inter-enterprise business has become dependent on rapid scheduling of events and actions using this information technology. Further, there has been developed a Specification (RFC 2445) for that has the objective of providing an interoperable calendaring and scheduling services for the Internet. This would allow group scheduling and Personal Information Management (PIM) data to be extended for use across the Internet. RFC 2445 provides the definition of a common format for openly exchanging calendaring and scheduling information across the Internet. The Specification is formatted as a registration for a MIME media type in accordance with RFC 2048. However, the format is equally applicable for use outside of a MIME message content type. The Specification proposes a media type value “text/calendar”. This string labels a media type containing calendaring and scheduling information encoded as text characters formatted in a specified manner. The MIME media type provides a standard content type for capturing calendar event, to-do and journal entry information. It also can be used to convey free/busy time information. The content type is suitable as a MIME message entity that can be transferred over MIME based email systems, using HTTP or some other Internet transport. In addition, the content type is useful as an object for interactions between desktop applications using the operating system clipboard, drag/drop or file systems capabilities.

There are several static telephony services, such as Do Not Disturb, Cancel Call Waiting and Call Forward Busy that are not controllable by a subscriber based on predetermined date/times and that are integrated with a RBT service offering. It would be advantageous to have a system and method that extends the RBT concept to allow a subscriber to further control the disposition of a call made by a calling party based on a calendar and scheduling software application controlled by the subscriber. The present invention provides such a system and method.

### SUMMARY

The present invention is a method and system for coupling, e.g., via the Internet or via other data channel, calendar and scheduling information or data from a calendar and scheduling software application to a functional node of a telecommunications system such as a service platform, an application server or service control point, similar to one that implements RBT service. Alternatively, the present invention is a node coupled to a telecommunication system, the node adapted to accept calendaring and scheduling information or data from a calendar and scheduling software application, and, based on such data, control the treatment of calls made to a subscriber. In either event, the application server has access to the subscriber's calendar, regardless of where it is maintained. When the terminating exchange queries the application server, it checks the subscriber's calendar and notifies or directs the terminating exchange as to what treatment an incoming call should be given. In this manner the subscriber can specify the treatment of calls placed to the subscriber based on the subscriber's calendar or scheduling software application. For example, if the subscriber indicates in the calendar that the subscriber is idle during a certain time period, then if a call is placed to the subscriber's terminal, a functional node of a telecommunications system, such as a service platform, an application server or service control point can cause the MSC to present the call and the subscriber's terminal will be signaled. If the subscriber indicates that he/she is busy during a certain period, then the call would not be signaled at the subscriber's terminal, rather it would be automatically directed to, e.g., a voicemail server or a RBT can be provided to the caller indicating that the subscriber is busy and that the caller should call back during the idle period (as indicated in the calendar software application). Variations on the foregoing can further be implemented. For example, in conjunction with the calendar software application, a priority list of individual or group of callers can be stored at the service platform, an application server or service control point such that the subscriber can indicate that such priority callers can signal the subscriber even if the calendar shows the subscriber as busy. The service provided by the present invention can be provisioned by the subscriber, e.g., through an Internet portal, or by contacting the subscriber's service provider, who then sets up the service.

### BRIEF DESCRIPTION OF THE SEVERAL VIEWS OF THE DRAWINGS

FIG. 1 is a flow chart of an embodiment of the method of the calendar based call treatment of the present invention; and

FIG. 2 is a block diagram of an embodiment of the system used to implement the present invention.

### DETAILED DESCRIPTION

The present invention is a method and system for coupling, e.g., via the Internet or via other data channel, calendar and scheduling information or data from a calendar and scheduling software application to a functional node of a telecommunications system that implements RBT, such as a service platform, an application server or service control point. Alternatively, the present invention is a node coupled to a telecommunication system, the node adapted to accept calendaring and scheduling information or data from a calendar and scheduling software application, and, based on such data, control the treatment of calls made to a subscriber. In either event, the application server has access to the subscriber's calendar, regardless of where it is maintained. When the terminating exchange queries the application server, it checks the subscriber's calendar and notifies or directs the terminating exchange as to what treatment an incoming call should be given. Using the present invention, an incoming call to a subscriber is a treatment based on the personal preference as indicated by the subscriber's calendar and according to priority of the caller as specified by the subscriber. Aspects of the present invention include, but are not limited to a specific, static call treatment against a caller or group of callers for one or more time periods as controlled by the subscriber's calendar software application. The service provided by the present invention can be provisioned by the subscriber, e.g., through an Internet portal, or by contacting the subscriber's service provider, who then sets up the service.

To specify a call treatment, the subscriber can, e.g., indicate his/her personal preference for the time period (e.g., using a date/hour/minute format). Such preferences, as made available by the calendar software program may include a variety of options. The present invention is not limited to the options described herein, as a variety of options having different designations and functions can be implemented in the present invention.

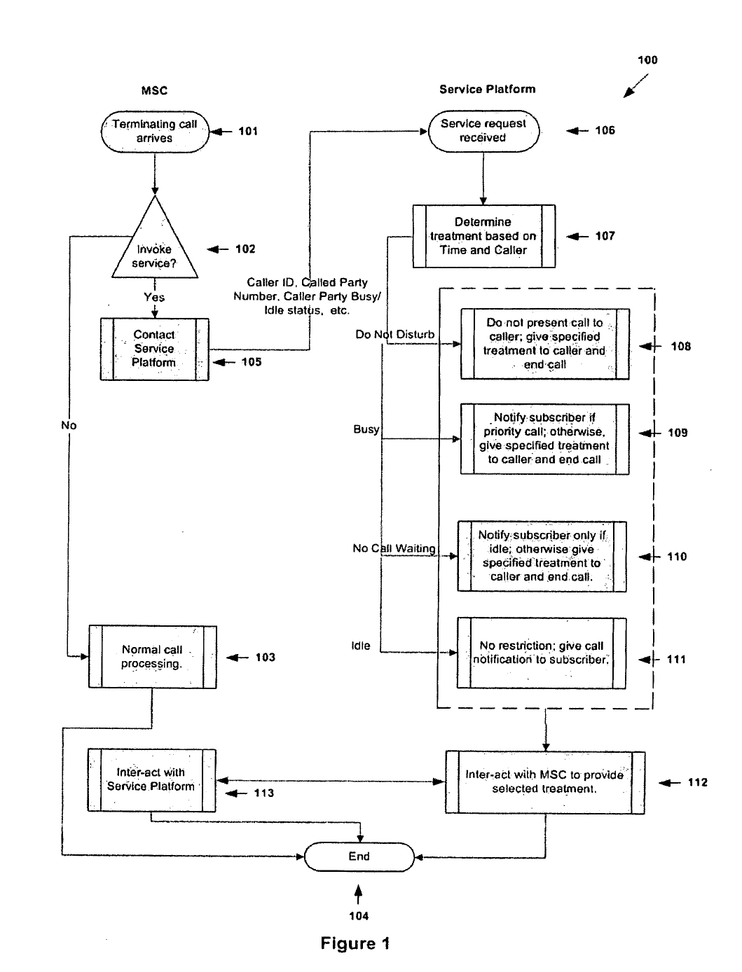

Referring the FIG. 1, a first embodiment of the present invention 100 is presented. As seen therein, a caller attempts to signal a called party and the call setup request arrives at an MSC at step 101. In step 102, it is determined whether the call treatment based on the called party's calendar is to be invoked. If not, then in step 103, conventional call processing occurs and the method terminates at step 104. If call treatment based on the called party's calendar is to be invoked in step 102, then a service platform is contacted in step 105 and the service platform receives the request in step 106. This service platform can also be, and may be referred to as, an application server or, in traditional telephony terms, a service control point working in conjunction with an interactive voice response (IVR) unit or an intelligent peripheral (IP) player, which is a media server. The application server alone or with other servers, hosts computer software that implements the present invention. If it is determined that the functionality of the present invention is to be applied, then, in step 107, the application server determines how the call is to be treated based on the options selected by the subscriber on his calendar software application and branches to one or more of steps 108 to 111 as described below. The options selected implement rules for the treatment of a call in steps 112 and 113. That is, upon receiving the service request, the application server queries its database to determine the rule or rules that the subscriber has specified for the treatment of the call that is being placed at that date and/or time period. In this manner, the treatment is dynamic, as determined by the subscriber, based on the date and time of the call, personal preferences of the subscriber, and the priority of the caller as assigned by the subscriber. The then method terminates at step 104.

A first exemplary rule may be designated as “Do Not Disturb” in step 108. The subscriber can highlight portions of, e.g., blocks of time during a specified date or dates, and select the “Do Not Disturb” rule to be applicable thereto. During the blocks of time that this rule is selected, no calls are signaled to the subscriber. Note however, that even though the subscriber is not signaled during the selected blocks of time, the subscriber may nevertheless be notified that a person called during the Do Not Disturb time period, for example, via a text (SMS), multimedia message (MMS), voicemail or e-mail or other similar message. Such message would include date and time information concerning the attempted call.

Another exemplary rule may be designated as “Busy” in step 109. The subscriber can highlight portions of, e.g., blocks of time during a specified date or dates, and select the “Busy” rule to be applicable thereto. If the subscriber indicates “Busy” during a specific time frame, then, e.g., only priority calls would be signaled. All other calls are given a different, specified treatment such as would be given if the “Do Not Disturb” rule were activated. The default rule would be no priority for any callers.

Another exemplary rule may be designated as “No Call Waiting” in step 110. The subscriber can highlight portions of, e.g., blocks of time during a specified date or dates, and select the “No Call Waiting” rule to be applicable thereto. If this rule is activated, then the call would be signaled to the subscriber only if he/she were not on another call. If the subscriber is on a call, then any calls made when the “No Call Waiting” rule is effective would be directed in accordance with, e.g., the “Do Not Disturb” or “Busy” rules, depending on the status of the caller as priority or non-priority.

Another exemplary rule may be designated as “Idle” in step 111. The subscriber can highlight portions of, e.g., blocks of time during a specified date or dates, and select the “Idle” rule to be applicable thereto. Alternatively, the default rule can be that Idle applies to all time periods or certain time blocks, e.g., 7 a.m. to 10 p.m. During an Idle time block, all calls are allowed.

The call treatment provided to a caller that is not signaled to the called party can also be selected by the subscriber. The call treatment may include, but is not limited to: playing a specified announcement and ending the call; forward the call to voicemail, or forward the call to a third party. As noted above, the caller can be sent a notification of the diverted call, for example, via an e-mail, text message or MMS message.

The method of the present invention includes the following steps: defining a set of rules for the treatment of a call, allowing a subscriber of a terminal to associate the set of rules with dates and times from a calendar and scheduling program, making the calendar and scheduling program available to a service platform of a telecommunications system, prior to signaling the terminal of the subscriber, determining the date and time of the call and then accessing, by the service platform, information from the calendar and scheduling program corresponding to the date and time of the call, and handling the call in accordance with the rules selected to apply to the date and time of the call.

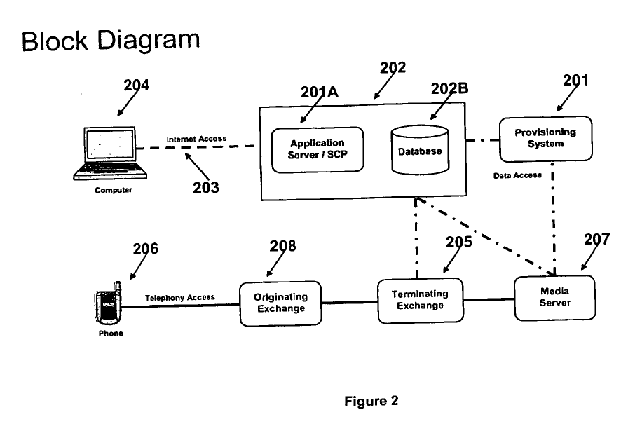

FIG. 2 is a block diagram of a system 200 that can be used to implement the present invention. As seen therein, the subscriber subscribes to the service provided by the present invention over a provisioning system 201. The provisioning system 201 is coupled to an application server/application database 200 and a media server 206. If the subscriber has subscribed, calendar and scheduling information or data from a calendar and scheduling software application is resident, or made available over the Internet 203 from either a computer 203 e.g., of the subscriber, or from the application database 202B to the application server 202A. The application server 202A is a functional node of a telecommunications system and includes, but is not limited to, a service platform, an application server or service control point. Based on such information or data, calls are provided certain treatment depending on the rules stored in, and invoked from database 202B. In the present invention, the application server 202A has access to the subscriber's calendar, regardless of where the calendar is maintained. When a terminating exchange 203 queries the application server 202A, the application server 202A checks the subscriber's calendar, e.g., from, e.g., the computer 204 or from the application database 202B, and notifies or directs the terminating exchange 205 as to what treatment an incoming call should be given. In this manner, the subscriber can specify the treatment of calls placed to the subscriber based on the subscriber's calendar or scheduling software application. For example, if the subscriber indicates in the calendar that the subscriber is idle during a certain time period, then if a call is placed to the subscriber's terminal (not shown), the application server 202A can cause the terminating exchange 205 to present the call from caller's terminal 206 the and the subscriber's terminal will be signaled. If the subscriber indicates that he/she is busy during a certain period, then the call would not be signaled at the subscriber's terminal, rather it would be automatically directed to e.g., media server 207 so that a voicemail or a RBT can be provided to the caller indicating that the subscriber is busy and that the caller should call back during the idle period (as indicated in the calendar software application). Generally, the application server 202A and associated application database 202B maintain the set of rules for the treatment of a call based on the calendar. Such application server 202A includes a computer program therein adapted to associate the set of rules with dates and times from a calendar and scheduling program. A bus is adapted to make the calendar and scheduling program and associated rules available to the application server 202A from the application database 202B. The present invention further includes an originating exchange 208, also referred to a a switching center, which is adapted to direct a service request of a calling party to the application server 202A or service platform prior to signaling the terminal of a subscriber. The application server 202A, or service platform further adapted to determine the date and time of the call, then access information from the calendar and scheduling program corresponding to the date and time of the call then and handle the call in accordance with the rules selected to apply to the date and time of the call. As noted, the subscriber calendar software application can reside internal or external to the application server. If it is external, the application server 202A is adapted to pull in information from the calendar and update its associated application database 202B.

The present invention can be maintained in a node for handling calls in a telecommunications system or distributed over several nodes, the nodes including at least a means for maintaining the set of rules for the treatment of a call and the means for associating the set of rules with dates and times from a calendar program and the means to intercept a call to the called party prior to signaling the call and treating the call in accordance with the set of rules applicable at that date and time. Further, the present invention can be embodied in a computer program adapted to be loaded into at least one memory and executed by at least one processor, the program including the calendar and scheduling program and the set of rules for the treatment of a call made in a telecommunications system based on date and time information from the calendar and scheduling program.

The present invention provides several advantages over the conventional call treatment. With the present invention, a subscriber can control the signaling of calls based on the time and status of the caller, thus allowing a subscriber to manage his/her calls. Hence a subscriber can block unwanted calls; provide an enhanced user experience to the caller due to the feedback given to the caller on the disposition of the called party at the time of the call; minimize repeated call attempts when a call is diverted or not answered or when a subscriber is not willing to accept calls; and improve the utilization of network resources as calls can be diverted more efficiently.

While particular embodiments of the present invention have been described, it is not intended that the present invention be limited thereto, as it is intended that the invention be as broad in scope as the art will allow and that the specification be read likewise. While the apparatus of the invention is shown in block diagram format, it will be appreciated that the block diagram may be representative of and implemented by hardware, software, firmware, or any combination thereof. Moreover, the functionality of certain aspects of the block diagram can be obtained by equivalent or suitable structure. It will therefore be appreciated by those skilled in the art that yet other modifications could be made to the provided invention without deviating from its spirit and scope as claimed.

What is claimed:

1. A method of handling a call in a telecommunications system, comprising the steps of:
defining a set of rules for the treatment of a call;
allowing a subscriber of a terminal to associate the set of rules with dates and times from a calendar and scheduling program;
making the calendar and scheduling program and associated rules available to a service platform of a telecommunications system;
prior to signaling the terminal of the subscriber, determining the date and time of the call and then accessing, by the service platform, information from the calendar and scheduling program corresponding to the date and time of the call; and
handling the call in accordance with the rules selected to apply to the date and time of the call.

2. The method of claim 1, wherein the calendar and scheduling program is internal to the service platform.

3. The method of claim 1, wherein the calendar and scheduling program is external to the service platform.

4. The method of claim 3, wherein information from the calendar and scheduling program accessed by the service platform over a network.

5. The method of claim 4, wherein the network is the Internet.

6. The method of claim 1, wherein the service platform is selected from the group consisting of: a RBT service platform, an application server and a service control point.

7. The method of claim 1, wherein a rule dictates that no calls be signaled to the subscriber.

8. The method of claim 1, wherein a rule dictates that only priority callers be signaled.

9. The method of claim 1, wherein a rule dictates that a call be signaled to the subscriber only if he/she is not then on another call.

10. The method of claim 1, wherein a rule dictates that all calls be signaled to the called party.

11. The method of claim 1, further comprising the step of notifying the called party of the diverted call.

12. The method of claim 12, wherein the notification is selected from the group consisting of an e-mail, voicemail, text message or multimedia message.

13. The method of claim 1, wherein any callers that are not signaled to the called party obtain a call treatment selected from the group consisting of at least one of: provided an announcement from a RBT server; diverted to voicemail, placed on hold, or redirected to a different telephone number.

14. The method of claim 1, wherein the method is provided as a service to a subscriber.

15. The method of claim 14, wherein the service is provisioned through an Internet portal.

16. The method of claim 14, wherein the service is provisioned by contacting the subscriber's service provider who then sets up the service.

17. A system for handling calls in a telecommunications system, comprising:
a service platform of a telecommunications system adapted to maintain a set of rules for the treatment of a call, the service platform adapted to determine the date and time of the call, then access information from a calendar and scheduling program corresponding to the date and time of the call and handle the call in accordance with the rules selected to apply to the date and time of the call.

18. The system of claim 17, further comprising a computer program adapted to be executed by a processor that associates the set of rules with dates and times from a calendar and scheduling program;
a bus adapted to make the calendar and scheduling program and associated rules available to the service platform; and
at least one exchange adapted to direct a service request of a calling party to the service platform prior to signaling the terminal of a subscriber.

19. The system of claim 17, wherein the calendar and scheduling program is a software application adapted to be loaded into the memory of, and executed by, the processor of the service platform.

20. The system of claim 17, wherein the calendar and scheduling program is a software application adapted to be loaded into the memory of, and executed by, a processor external to the service platform.

21. The system of claim 17, wherein information from the calendar and scheduling program is accessed by the service platform over a network.

22. The system of claim 21, wherein the network is the Internet.

23. The system of claim 17, wherein the service platform is selected from the group consisting of: a RBT service platform, an application server and a service control point.

24. The system of claim 17, wherein a rule dictates that no calls be signaled to the subscriber.

25. The system of claim 17, wherein a rule dictates that only priority callers be signaled.

26. The system of claim 17, wherein a rule dictates that a call be signaled to the subscriber only if he/she is not then on another call.

27. The system of claim 17, wherein a rule dictates that all calls be signaled to the called party.

28. The system of claim 17, wherein the service platform is adapted to notify the called party of the diverted call.

29. The system of claim 27, wherein the notification is selected from the group consisting of an e-mail, voicemail, text message or multimedia message.

30. The system of claim 17, wherein any callers that are not signaled to the called party obtain a call treatment selected from the group consisting of at least one of: provided an announcement from a RBT server; diverted to voicemail, placed on hold, or redirected to a different telephone number.

31. A node for handling calls in a telecommunications system, comprising:
a means adapted to maintain a set of rules for the treatment of a call;
a means for associating the set of rules with dates and times from a calendar program; and
a means to intercept a call to the called party prior to signaling the call and treating the call in accordance with the set of rules applicable at that date and time.

32. A node in a telecommunications system, comprising a service platform having an application server and application database, the service platform adapted to:
maintain a set of rules for the treatment of a call, the service platform adapted to determine the date and time of the call;
access information from a calendar and scheduling program corresponding to the date and time of the call; and
handle the call in accordance with the rules selected to apply to the date and time of the call.

33. A computer program adapted to be loaded into at least one memory and executed by at least one processor, comprising:
a calendar and scheduling program; and
a set of rules for the treatment of a call made in a telecommunications system based on date and time information from the calendar and scheduling program.
